(19) United States
(12) Patent Application Publication
(10) Pub. No.: US 2023/0036713 A1
(43) Pub. Date: Feb. 2, 2023

(54) Borehole Image Gap Filing Using Deep Learning

(71) Applicant: Halliburton Energy Services, Inc., Houston, TX (US)

(72) Inventors: Sonali Pattnaik, Houston, TX (US); Songhua Chen, Katy, TX (US); Mahmoud Eid Selim, Khobar (SA)

(21) Appl. No.: 17/392,058

(22) Filed: Aug. 2, 2021

(51) Int. Cl. E21B 47/002; G06T 5/00; G06T 5/50

(52) U.S. Cl. CPC E21B 47/002; G06T 5/005; G06T 5/50; G06T 2207/20081; G06T 2207/20084; G06T 2207/30181

(57) ABSTRACT

System and methods for image gap-filling are provided. An image of a rock formation is obtained from an imaging tool disposed within a borehole. The obtained image is analyzed to identify gaps of missing image data. One or more image masks corresponding to the identified gaps are generated. A machine learning model is trained to produce modeled image data for filling in the missing image data in the identified gaps, based on the generated image mask(s). The image is reconstructed by filling the gaps of missing image data with the modeled image data. The reconstructed image is analyzed to identify geological features of the rock formation.

### FIELD OF THE DISCLOSURE

The present disclosure relates generally to formation image analysis and particularly, to filling gaps in downhole image data to facilitate automated image analysis and formation evaluation.

### BACKGROUND

Borehole image logging is a useful tool for complex reservoir and formation analysis. The image logs captured from a borehole drilled within a subsurface formation may be used to evaluate the formation, e.g., for purposes of locating bedding plane dips, identifying irregular geological features, such as vugs and fractures, obtaining accurate sand counts in thin bedded zones, and identifying stratigraphic variations at different stages of a drilling operation. For example, such borehole image logs may be used to locate breakouts or other irregularities along the borehole while drilling induced fractures as well as thinly bedded rock layers during formation evaluation prior to drilling. However, the spacing between the discrete sensors and pads of a typical borehole imaging tool used to capture image data from the surrounding formation tends to leave gaps in the captured image. The portions of the formation located between adjacent pads may not be sensed, resulting in multiple gaps in the captured image log. The width of the gaps varies with the hole size. The bigger the hole, the bigger the gaps due to insufficient pad coverage. Such gaps in borehole circumference image data complicates borehole image interpretation, especially for heterogeneous pore systems, such as those common to carbonate rock formations. Moreover, such gaps make automated image analysis more challenging. In addition to borehole images, many other types of formation images, such as those used for core analysis may suffer from gaps caused by irregular patterns of missing data, which may be due to limitations in the imaging instruments used to acquire the data as well as optical artifacts introduced by a particular imaging technology used for certain types of formation. Examples of such core analysis images include, but are not limited to, (1) whole core slab photos with gaps created by coring of plugs and irregularly broken whole cores, (2) surface roughness images with irregular patterns of missing data (e.g., images produced by Laser Scanning Microscopy, White Light Interference Microcopy, etc.), and (3) thin section images marred by blackspots.

### BRIEF DESCRIPTION OF THE DRAWINGS

FIG. 1 is a diagram of an illustrative drilling system in which embodiments of the present disclosure may be implemented.

FIG. 2 is a system for filling formation image gaps using machine learning, in accordance with embodiments of the present disclosure.

FIG. 3A is a representative image of a borehole containing image gaps, in accordance with embodiments of the present disclosure.

FIG. 3B is a representative image mask identifying the image gaps in the borehole image of FIG. 3A, in accordance with embodiments of the present disclosure.

FIG. 4 is a stacked U-Net architecture of a deep learning model for image gap-filling, in accordance with embodiments of the present disclosure.

FIG. 5A is a representative input image of a borehole containing image gaps to be filled in accordance with embodiments of the present disclosure.

FIG. 5B is a representative output image of the borehole in FIG. 5A with the image gaps filled in accordance with embodiments of the present disclosure.

FIG. 6A is a representative input image of a thin section of a borehole with masks corresponding to image gaps of different shapes and sizes arbitrarily located throughout the image, in accordance with embodiments of the present disclosure.

FIG. 6B is a modeled image of the thin section produced by a deep learning model trained using the masked input image in FIG. 6A, in accordance with embodiments of the present disclosure.

FIG. 6C is a reconstructed image of the thin section output by the trained deep learning model using the modeled image data in FIG. 6B, in accordance with embodiments of the present disclosure.

FIG. 7 is a flowchart of an illustrative process for creating a gap-filled image log, in accordance with embodiments of the present disclosure.

FIG. 8 is a block diagram of an illustrative computer system in which embodiments of the present disclosure may be implemented.

### DESCRIPTION OF ILLUSTRATIVE EMBODIMENTS

Embodiments of the present disclosure relate to image gap filling. More specifically the present disclosure relates to smooth filing of the missing data, of varying shapes and sizes, in an image using deep learning model (e.g., a machine learning algorithm), such as a U-Net model. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to implement such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As will be described in further detail below, embodiments of the present disclosure may be used to infill gaps in images, such as whole core images, borehole images, resistivity logs, or thin section images, using a deep learning model (e.g., a machine learning algorithm or deep neural network). More specifically, embodiments, of the present disclosure relate to training and using such a deep learning model to automatically fill in gaps of missing image data, which may appear in a borehole image as irregular hole patterns of varying shapes and sizes. The irregular hole patterns in the image may be updated by the deep learning model by, for example, changing the value of an image pixel. The irregular hole patterns in the image may include complex geologic and formation information like irregular features including vugs, faults, and fractures, borehole breakout, or thinly bedded laminations in the formation, and/or the like. In this regard, infilling irregular hole patterns of varying shapes and sizes in the image may include formation information associated with the surrounding rock fabric and/or the like. Moreover, automatically infilling the irregular holes in the image may involve filling in the image without user intervention (e.g. no user input). Thus, unlike conventional statistics-based or computer vision-based techniques for formation image gap filling, the disclosed techniques are not inhibited by image artifacts or irregular borehole patterns of varying shapes and sizes. While embodiments of the present disclosure may be described in the context of image logs obtained from a borehole, it should be appreciated that embodiments are not intended to be limited thereto and that the disclosed image gap-filling techniques may be applied to a variety of downhole image data. Examples of such image data include, but are not limited to, core images, borehole images, resistivity logs, thin section images, and any other image of a subsurface formation or portion thereof.

In some embodiments, the automatic infilling of the irregular holes by the deep learning model may map a fault or other geologic feature within an image. As an illustrative example, a borehole breakout caused by drilling may be infilled using different images, taken at different times in slightly different locations, of the surrounding borehole. To that end, the deep learning model may infill the missing data using the first image and subsequently update that same data location based on a second image.

In some embodiments, training the deep learning model may involve applying an image mask indicating whether or not each pixel of an image contains data. Each image input into the deep learning model may have an image mask associated with it such that the deep learning model may know if data exists at the pixel or if the pixel is one that is missing and must be infilled.

In some embodiments, training the deep learning model may involve obtaining training image data as well as corresponding mask data. Training of the deep learning model may involve training the deep learning model based on, for example, a training image and the corresponding image mask. In some embodiments, the deep learning model may be trained via supervised learning. For example, the training of the deep learning model to fill in gaps of missing data identified within the input image may be validated by a user (e.g., via user input) and/or based on a set of validation data. This supervised image gap filling may include, for example, retraining or adjusting parameters of the deep learning model based on the validation performed by the user.

Conventional solutions for borehole image gap filling use general statistics and interpolation-based techniques or computer vision-based techniques to infill the gaps in the borehole image. However, these solutions are inhibited by several artifacts and inability to handle irregular hole patterns of varying shapes and sizes. The resulting image using these methods is filled with discontinuity in the bedding where the image contained a gap. Furthermore, spurious or incorrect data when infilling the image gaps adversely affects the training model used for interpretation.

By contrast, the disclosed techniques use a semantically aware approach based on rock lithofacies data, convolutional neural networks, and a machine learning neural network to assist with infilling the gapped images. Image infilling means a smooth filling of missing image pixels so that the output aligns well with the rest of the image. This approach uses partial convolutions, computer vision techniques, and machine learning methods, including deep neural networks, to create a fully automated process for facies interpretation. This approach is not limited to borehole images but can be applied to any image of a subsurface formation with missing data of any shape or size. This approach may be applied to, for example, thin section images, surface roughness images, resistivity measurements, and the like.

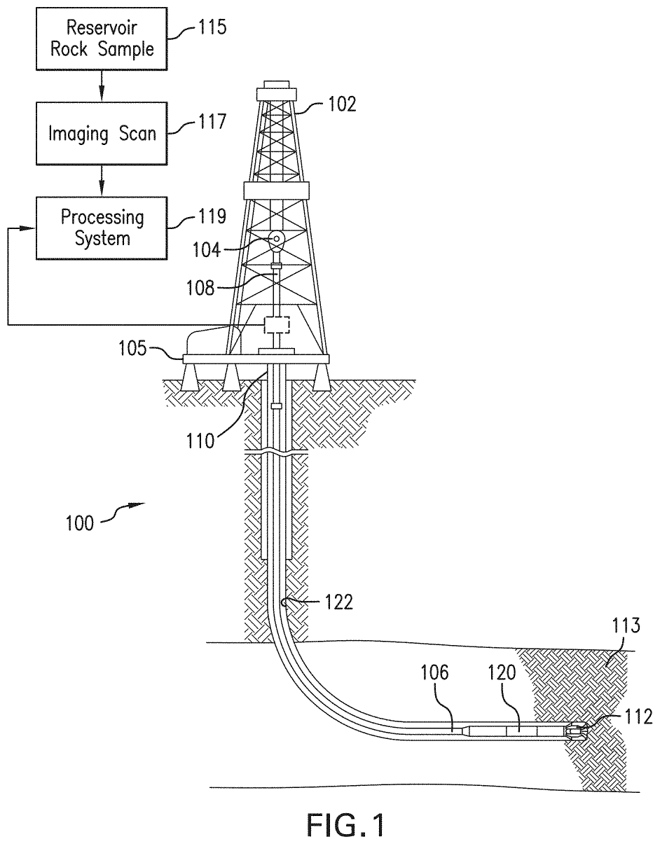

Illustrative embodiments and related methodologies of the present disclosure are described below in reference to FIGS. 1-8 as they might be employed, for example, in a computer system for image analysis and formation evaluation for purposes of well planning. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 is a diagram of an illustrative drilling system 100. In accordance with the present disclosure, the drilling system 100 may be used to image a borehole or retrieve a reservoir rock sample, such as a core sample, for reservoir formation evaluation and rock classification. As shown in FIG. 1, drilling system 100 includes a drilling platform 105 equipped with a derrick 102 that supports a hoist 104. Drilling in accordance with some embodiments is carried out by a string of drill pipes connected together by “tool” joints so as to form a drill string 106. Hoist 104 suspends a top drive 108 that is used to rotate drill string 106 as the hoist lowers the drill string 106 into a borehole 122 through wellhead 110. The drilling of borehole 122 through a subsurface reservoir formation 113 may be accomplished by rotating drill string 106 by top drive 108 or by use of a downhole “mud” motor (not shown) that turns a drill bit 112 by a combination of both top drive 108 and a downhole mud motor. It should be appreciated that borehole 122 may be drilled over multiple sections along a planned path through different formation layers in any combination of horizontal, vertical, slant, curved, and/or other orientations. The subsurface reservoir formation 113 may include a reservoir that contains hydrocarbon resources, such as oil, natural gas, and/or others. For example, the reservoir formation 113 may be a rock formation (e.g., shale, coal, sandstone, granite, and/or others) that includes hydrocarbon deposits, such as oil and natural gas. In some cases, the reservoir formation 113 may be a tight gas formation that includes low permeability rock (e.g., shale, coal, and/or others). The reservoir formation 113 may be composed of naturally fractured rock and/or natural rock formations that are not fractured to any significant degree.

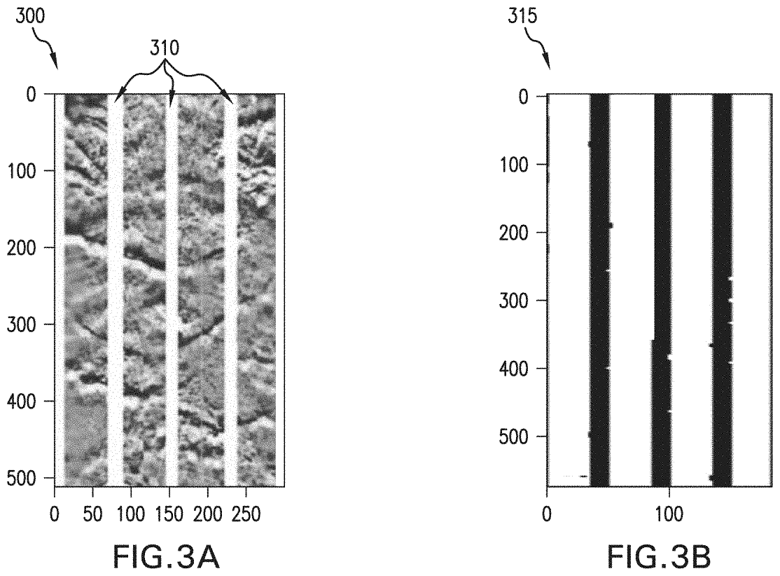

As shown in FIG. 1, a downhole assembly including a borehole imaging tool 120 may be connected to the lower end of drill string 106 for capturing images of the surrounding reservoir formation 113 as borehole 122 is drilled along the planned path. In one or more embodiments, borehole imaging tool 120 may be used to capture a series of image logs around a circumference of the borehole 122 as it is drilled along its planned path. Such borehole image logs may be captured as different sections of the borehole 122 are drilled over different depth or time intervals, where each interval corresponds to a different section of the borehole 122 along a portion of the planned path. In one or more embodiments, the captured image logs may be stored as two-dimensional (2D) scalar arrays of numerical values (e.g., values of formation resistivity), which vary according to the type of underlying rock formation represented by the image. In some implementations, borehole imaging tool 120 may be a resistivity imaging tool, and the image logs may be constructed from resistivity measurements made by pad-mounted arrays of electrodes arranged along an outer surface or housing of the borehole imaging tool 120. In this arrangement of pad-mounted electrodes, the coverage area of the borehole imaging tool 120 may depend upon the distribution of the electrode arrays in relation to the circumference of the borehole 122. Images rendered from resistivity values measured by the pad-mounted electrodes of borehole imaging tool 120 may include gaps of missing image data, as will be described in further detail below with reference to FIGS. 3A and 3B.

Although not shown in FIG. 1, it should be appreciated that drill string 106 may also include any number of additional downhole tools. Examples of such tools include, but are not limited to, measurement-while-drilling (“MWD”) tools and logging-while-drilling (“LWD”) tools for acquiring real-time measurements of various formation parameters as the borehole 122 is drilled along its planned path.

In one or more embodiments, the drill string 106 may include a reservoir rock sample collection tool (not shown). The reservoir rock sample collection tool may be attached to, for example, drill bit 112 at a distal end of drill string 106 for collecting a reservoir rock sample (e.g., a core or plug sample) cut by drill bit 112 from formation 113. In some implementations, the reservoir rock sample collection tool may include a separate coring tool to extract a reservoir rock sample 115 during the drilling operation along with a hollow chamber to collect and store the rock sample for later retrieval and analysis. For example, an imaging scan 117 may be performed on the reservoir rock sample 115 retrieved from the rock sample collection tool at the surface. In some embodiments, the imaging scan 117 may capture image data of the reservoir rock sample 115. In some embodiments, the image data may include a sequence of two-dimensional images of the reservoir rock sample 115 that together form three-dimensional image data of the reservoir rock sample 115. Further, the image data may include a computed tomography (CT) image, a magnetic resonance imaging (MRI) image, an ultrasound image, and/or the like. To that end, the imaging scan 117 may be performed by any suitable imaging device including, for example and without limitation, a CT imaging device, a microCT imaging device, an MRI imaging device, an ultrasound imaging device, or the like. While the reservoir rock sample 115 and imaging scan 117 are illustrated proximate the drilling system 105, it should be appreciated that the reservoir rock sample 115 may be performed either in the field (e.g., at the wellsite) or at a remote location to which the rock sample 115 may be transported for the imaging scan 117. Accordingly, the imaging scan 117 may be performed within a laboratory or a separate geographical location away from the drilling platform 105 and wellsite.

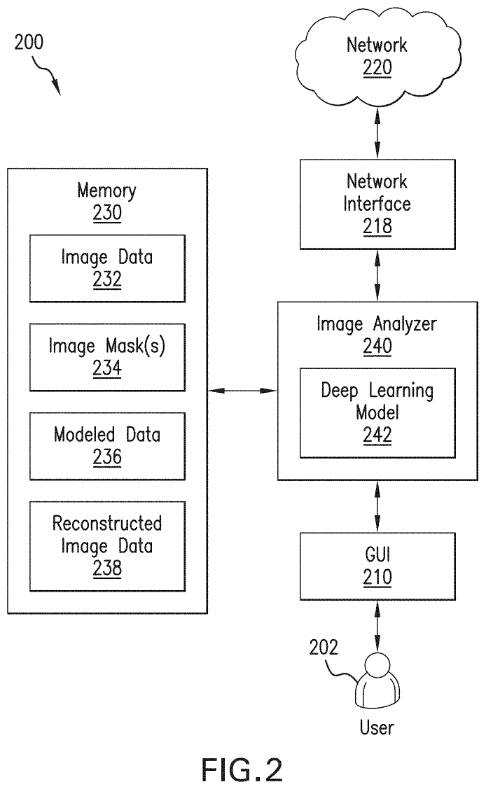

The image data produced by imaging scan 117 or captured by borehole imaging tool 120 may be provided to a processing system 119 for performing the automated image analysis and gap-filling techniques disclosed herein. While processing system 119 is shown next to drilling platform 105 in FIG. 1, it should be appreciated that processing system 119 may be a remote processing system located away from the wellsite and communicatively coupled via a network to a surface control unit or processing system (not shown) located at the wellsite. Processing system 119 may be implemented using any type of computing device having at least one processor and a processor-readable storage medium for storing data and instructions executable by the processor. Examples of such a computing device include, but are not limited to, a mobile phone, a personal digital assistant (PDA), a tablet computer, a laptop computer, a desktop computer, a workstation, a server, a cluster of computers, such as in a server farm, or other type of computing device. In some embodiments, processing system 119 may be implemented using, for example, system 200 of FIG. 2, as will be described in further detail below.

FIG. 2 is a block diagram of an exemplary system 200 for filling formation image gaps. For example, system 200 may be used to automatically fill in gaps of missing image data acquired from a reservoir rock formation. The gap-filled images may then be analyzed for formation evaluation and rock type classification. In some embodiments, such image data may include image logs obtained from a borehole imaging tool, e.g., borehole imaging tool 120 of FIG. 1, as described above. However, it should be appreciated that embodiments are not intended to be limited thereto and that the disclosed gap-filling techniques may be applied to other images of the borehole or formation, e.g., core sample images produced by imaging scan 117 of FIG. 1, as described above.

As shown in FIG. 2, system 200 includes a graphical user interface (GUI) 210, a network interface 218, a memory 230, and an image analyzer 240. In some embodiments, GUI 210, network interface 218, memory 230, and image analyzer 240 may be communicatively coupled to one another via an internal bus of system 200. Like processing system 119 of FIG. 1 described above, system 200 may be implemented using any type of computing device. The computing device may include an input/output (I/O) interface for receiving user input or commands via GUI 210 or a user input device (not shown) coupled thereto. The user input device may be, for example and without limitation, a mouse, a QWERTY or T9 keyboard, a touch-screen, or a microphone. The I/O interface also may be used by system 200 to output or present information to a user via GUI 210 or an output device (not shown) coupled thereto. The output device may be, for example, a display coupled to or integrated with the computing device for displaying a digital representation of the information being presented to the user. In some implementations, system 200 may be a server system located in a data center associated with a drilling system, e.g., drilling system 100 of FIG. 1, or the hydrocarbon producing field as a whole. The data center may be, for example, physically located in or near the field. Alternatively, the data center may be at a remote location away from the hydrocarbon producing field.

Although only GUI 210, network interface 218, memory 230, and image analyzer 240 are shown in FIG. 2, it should be appreciated that system 200 may include additional components, modules, and/or sub-components as desired for a particular implementation. It should also be appreciated that GUI 210, network interface 218, memory 230, and image analyzer 240 may be implemented in software, firmware, hardware, or any combination thereof.

As will be described in further detail below, memory 230 can be used to store information accessible by image analyzer 240 and/or the GUI 210 for implementing the functionality of the present disclosure. Memory 230 may be any type of recording medium coupled to an integrated circuit that controls access to the recording medium. The recording medium can be, for example and without limitation, a semiconductor memory, a hard disk, or similar type of memory or storage device. In some implementations, memory 230 may be a remote data store, e.g., a cloud-based storage location, communicatively coupled to system 200 over a network 220 via network interface 218. Network 220 can be any type of network or combination of networks used to communicate information between different computing devices. Network 220 can include, but is not limited to, a wired (e.g., Ethernet) or a wireless (e.g., Wi-Fi or mobile telecommunications) network. In addition, network 220 can include, for example and without limitation, a local area network, a medium area network, or a wide area network, such as the Internet.

As shown in FIG. 2, memory 230 may be used to store image data 232. Image data 232 may include, for example, image logs obtained from a borehole imaging tool, e.g., borehole imaging tool 120 of FIG. 1, as described above. In some embodiments, image data 232 may be stored in memory 230 as 2D scalar arrays of resistivity values measured by pad-mounted sensors (e.g., electrodes) of the imaging tool around a circumference of a borehole (e.g., borehole 122 of FIG. 1) being drilled within a subsurface formation. For example, the resistivity measurements may be collected by the borehole imaging tool over a series of depth or time intervals along a planned path of the borehole within the formation. Accordingly, in some embodiments, the image data 234 may include a series of depth-defined borehole image logs corresponding to different sections of the borehole drilled along its planned trajectory within the formation. As described above, the coverage area of the borehole imaging tool may depend upon the distribution of the sensor elements (e.g., electrode pads) in relation to the size and circumference of the borehole. For example, there may be gaps between the individual sensors of the tool when the sensor distribution of the tool is insufficient to cover the entire area around the circumference of the borehole or produce a continuous image log without gaps. The size of the gaps in the sensor coverage area (and thus, the size of the gaps in the captured image log) becomes more pronounced as the size and circumference of the borehole grows larger.

In some embodiments, the training data 232 may additionally or alternatively be obtained from a database. In particular, the training data 232 may be communicated from the database via the network 220 and/or the network interface 218. In some embodiments, for example, the training data 232 may be stored within the memory 230 after it is communicated from the database (not shown). The database may be any type of data storage device, e.g., in the form of a recording medium coupled to an integrated circuit that controls access to the recording medium. The recording medium can be, for example and without limitation, a semiconductor memory, a hard disk, or similar type of memory or storage device accessible to system 200. Further, a database may be implemented as a remote database communicatively coupled to system 200 via network 220.

In some embodiments, each image log may be analyzed by image analyzer 240 to identify gaps. The gaps may be identified, for example, by analyzing the image to find locations where the image data (e.g., resistivity values) are missing. In certain implementations, each pixel of the image may be associated with a resistivity value based on measurements made by the imaging tool (or other sensor coupled to the drill string) for a corresponding location around a circumference of the borehole (and corresponding depth within the formation). In some embodiments, one or more image log masks (or “image mask(s)”) 234 corresponding to the gaps of missing data identified by image analyzer 240 in at least one of the image logs included within image data 232 may be generated and stored within memory 230. The image mask(s) 234 that are generated may be unique to a corresponding image log in the set of analyzed image logs. Also, a different image mask may be generated for each image log in which a gap or missing image data has been identified. While the image mask(s) 234 described in this example may correspond to one or more areas of missing image data in an image log, it should be appreciated that the generated image mask in other implementations may correspond to identified area(s) (e.g., an image element or pixel) of an image log in which data is present (i.e., continuous with no data gaps). Also, which the image mask 234 may be stored in association with the image data 232 in the example shown in FIG. 2, it should be appreciated that the image mask in a different implementation may be included in metadata (e.g., a header) of the corresponding image log in image data 232.

FIG. 3A shows an example of a borehole image 300 produced from image logs containing gaps 310, which appear in this example as vertical or near-vertical strips of missing image data. Image gaps 310 may occur whenever the borehole circumference exceeds the total width of the mounted sensor (electrode) pads of the borehole imaging tool, as described above. Thus, image gaps 310 may correspond to non-imaged portions of an otherwise continuous borehole image log. In some embodiments, color equalization may be applied to different types of images produced from the image logs captured by a downhole imaging tool. The different types of images may include, for example and without limitation, a dynamic image and a static image of the borehole circumference over one or more depth intervals. In the case of a dynamic image, the color equalization may be applied to different areas of the image using a sliding window. For a static image, the color equalization may be performed for the whole borehole image. In some embodiments, the use of dynamic images with color equalization may enhance local contrast and thereby, reveal irregular geological features of the formation, such as fractures, vugs, anticlines, etc., more appropriately in the final image.

FIG. 3B illustrates an example of a mask 315 identifying missing data in the image logs associated with the image 300 shown in FIG. 3A. In some embodiments, the mask 315 may be created by thresholding or clustering and picking up the appropriate cluster that corresponds to the gaps in the image logs. If noise is present in the mask where extra gaps are selected instead of only the gaps caused due to missing data in the image log, the noise may be removed by, for example and without limitation, morphological image processing operations, like dilation. The image mask 315 in FIG. 3B may be the same size as the input image logs.

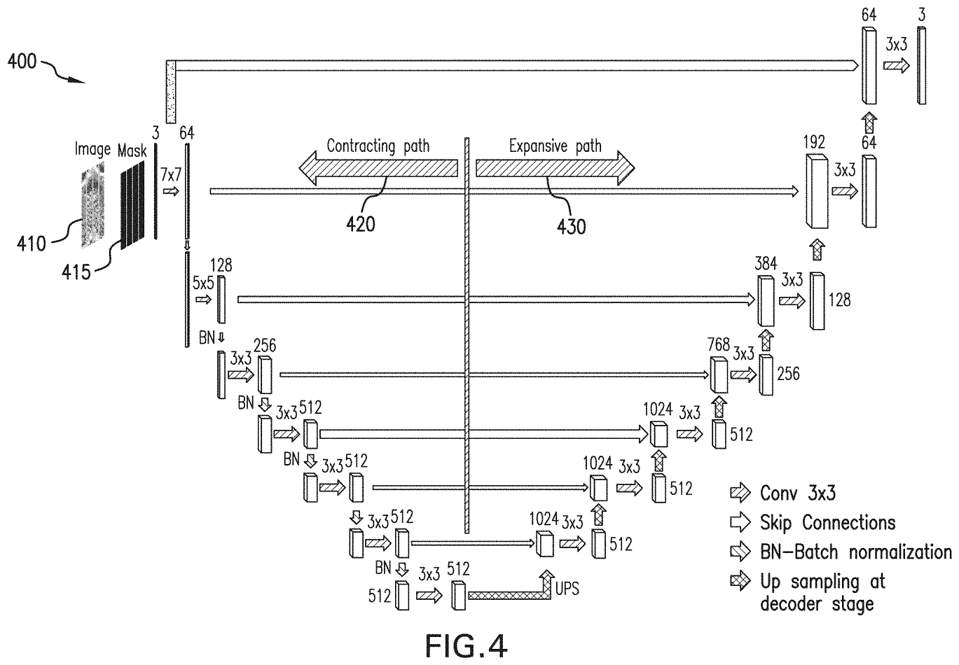

Returning to FIG. 2, image analyzer 240 of system 200 may include a deep learning model 242 (e.g., a machine learning algorithm or neural network). In particular, the deep learning model 242 may be implemented to output multiple channels. For instance, the deep learning model 242 may be implemented using a three-dimensional (3D) U-Net architecture with multiple output channels (e.g., a multi-net model). As shown in FIG. 4, such a U-Net model is generally characterized by a “U” shape defined by downsampling an input (e.g., an input image) to different classes (e.g., channels) and then upsampling the data back to an original size (e.g., resolution).

FIG. 4 is an example of a U-Net architecture 400, which may be used to implement deep learning model 242 of system 300, as described above. In one or more embodiments, the U-Net architecture 400 may be used to train deep learning model 242 for image gap-filling. However, it should be appreciated that the disclosed techniques are not intended to be limited to the U-Net architecture. Advantages of such an architecture relative to other neural network architectures may include, for example, high performance, easy trainability, and adaptability on small datasets. Using convolution operations (shown by horizontal arrows) across multiple levels (or layers) of the architecture 400, filters of appropriate size are convolved with the input image so that the depth of the image is increased from 3 to 64. This process is repeated several times.

As shown in FIG. 4, U-Net architecture 400 includes an encoding (or contracting) path 420 and a decoding (or expansive) path 430 for capturing relevant context information at multiple scales. The operations performed at each level/layer of the encoding path 420 may include batch normalization (BN). Batch normalization makes the convolutional neural network more stable and faster by reducing the internal covariate shifts through normalization of each layer's inputs by re-centering and re-scaling. The contracting path 420, or the encoder, applies max pooling operations to encode the input into feature representations at each of the multiple levels/layers. The expansive path 430, or the decoder, uses several upsampling operations to semantically project the low-resolution representation learned by the encoder onto high resolution. Essentially, the image is resized to original size by applying several upsampling operations.

A typical U-Net performs image inpainting by initializing the holes with some constant values which causes the network to learn many artifacts as well that need additional post-processing techniques. Hence, the convolutional layers are replaced with partial convolutional layers and nearest neighbor up-sampling is used in the decoding stage. The image mask 415 is automatically updated after each partial convolutional layer until all the missing data is removed from the image log 410. This method uses partial convolution which includes but is not limited to a convolution step which is conditioned on at least one valid input pixel value, for the next partial convolutional layer, that location is updated as a valid and the convolution step does not occur where the location is updated as invalid. Whether the convolution step occurs depends on the location of valid pixel values only.

The loss functions or functions (not shown) provides some indication of how good the model is performing per-pixel reconstruction accuracy as well as determine the smoothness of completed or in-filled image logs by understanding the transition of hole values into their surrounding context.

In the last layer, the skip connection connects the original input image log with gaps and the original image mask, to the modeled output images and the mask so that the non-hole pixels are just copied.

In this way, an advantage of implementing the deep learning model 242 as the 3D U-Net model is that a resolution of the output (e.g., one or more output images) of the 3D U-Net model may substantially match a resolution of an input (e.g., an input image) to the model. The deep learning model 242 may additionally or alternatively be implemented as a convolutional neural network (CNN) or any other suitable machine learning algorithm. In some embodiments, the deep learning model 242 may be a single model capable of outputting multiple channels. In some embodiments, to output multiple different channels, the deep learning model 242 may include a number of different models (e.g., a different deep learning models). For instance, the deep learning model 242 may include a first model configured to output a first output channel (e.g., associated with segmentation into the first output channel) and a different, second model configured to output a second output channel (e.g., associated with segmentation into the second output channel). The first model and the second model may be implemented as the same type of model (e.g., a first 3D U-Net model and a second 3D U-Net model) or as different deep learning models.

Returning again to FIG. 2, deep learning model 242, e.g., as implemented using the U-Net architecture of FIG. 4, may be trained to produce modeled image data 236 for filling in the missing image data in the gaps identified in at least one of the image logs in image data 232, based on the one or more generated image masks 234. In some embodiments, the modeled data 236 may be used to produce reconstructed image data 238. As shown in FIG. 2, modeled image data 236 and reconstructed image data 238 may be stored in memory 230.

In some embodiments, the reproduced image data 238 including the filled gaps of borehole image logs may be displayed via the GUI 210. For instance, the image may be output to the GUI 210, which may be provided on a display (e.g., an electronic display). The display may be, for example and without limitation, a cathode ray tube (CRT) monitor, a liquid crystal display (LCD), or a touch-screen display, e.g., in the form of a capacitive touch-screen light emitting diode (LED) display.

In some embodiments, GUI 210 enables a user 202 to view and/or interact directly with the borehole image. In particular, a user input may be provided to modify, accept, or reject the reproduced image data 238. In some embodiments, the reproduced image data 238 may thus be updated based on a user input. Furthermore, additional input received from user 202 via GUI 210 may be used to after the training of the deep learning model 242, as described above. The GUI 210 may additionally or alternatively receive a user input to generate the model, to generate a particular data visualization, to run a particular simulation with the model, to adjust a characteristic of the model, or how the borehole image data is visualized.

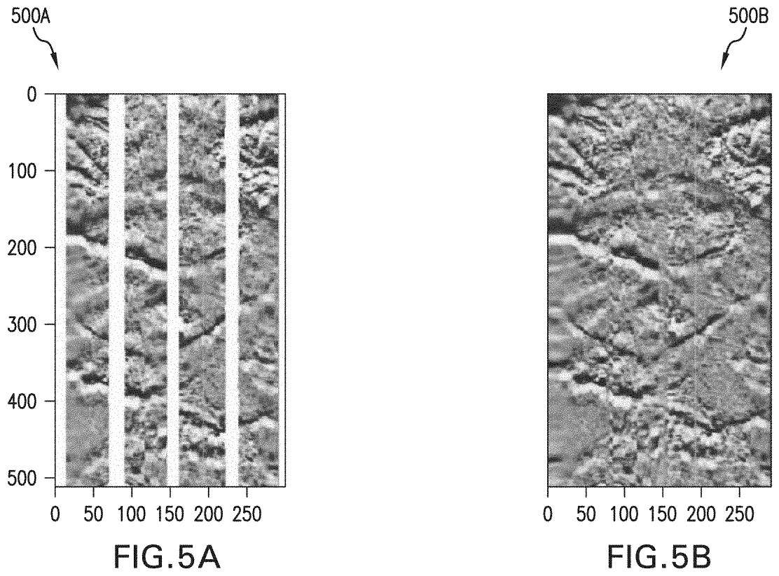

FIG. 5A is an example of an image 500A produced from borehole image logs containing gaps. FIG. 5B is an example of an image 500B produced from reconstructed image logs using the disclosed gap-filling techniques, e.g., as performed by deep learning system 200 of FIG. 2, as described above. The stacked U-Net machine learning input consisted of 10,000 dynamic images. Each image is resized to 200×200 pixels like the thin section process. However, images of any size will work. To increase the prediction accuracy and ensure that each part of the borehole is well-represented in training samples. The training data 232 contains training samples with at least 20% overlap.

By convention, low resistivity features, such as shales or conductive mud-filled fractures, are displayed as dark colors. High resistivity features, such as quartz or calcite cemented nodules or bands in sandstones and tightly cemented carbonates, are displayed as shades of yellow and white. The high and the low resistive patterns have been picked up by the model automatically and enables recognition of similarities. This will serve as features set for further facies classification. However, embodiments are not intended to be limited thereto.

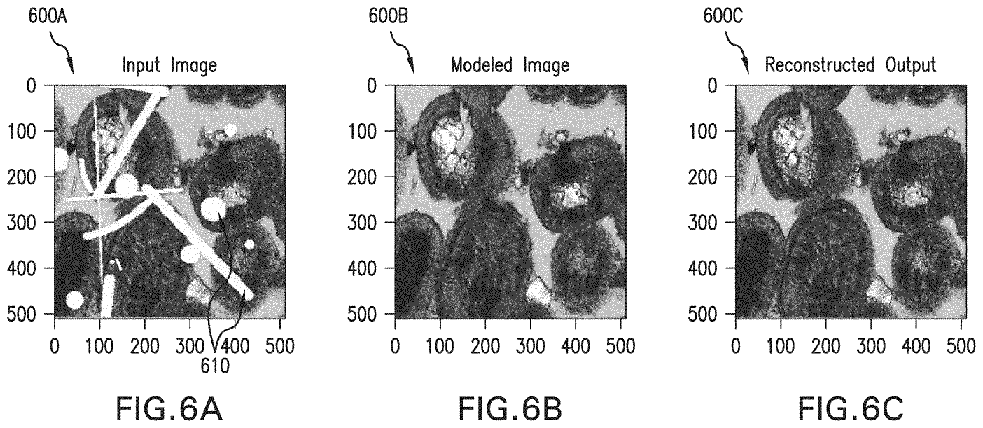

FIG. 6A is an input image 600A of a thin section of a borehole with masks 610 corresponding to gaps of missing image data arbitrarily located throughout the image. As shown in FIG. 6A, image gaps and corresponding masks 610 are of different shapes and sizes. In one or more embodiments, a deep learning model (e.g., deep learning model 242 of FIG. 2, as described above) trained using the masked input image 600A may be used to create a modeled image 600B, as shown in FIG. 6B. The trained deep leaning model may output, for example, a reconstructed image 600C of the thin section, as shown in FIG. 6C, using the modeled image data in FIG. 6B.

Image 600C of the thin section in FIG. 6C may be, for example, a representation of a complete thin section image that is generated or “reconstructed” by replacing the masked regions 610 in image 600A with corresponding regions of modeled image data from image 600B produced by the deep learning model. In some implementations, the deep learning model may have a stacked U-Net architecture, as shown in FIG. 4 and described above. It should be appreciated that the input image data applied to the stacked U-Net architecture of the deep learning model in this example may include various input images of the thin section with image gaps. Each image may be resized uniformly according to a default or predetermined image size (e.g., 200×200 pixels), which may be selected as desired for a given implementation. Alternatively, input images of different sizes may be used. The deep learning model may be trained using, for example, training image samples with some amount of overlap (e.g., at least 20% overlap) in the image data. Furthermore, a different set of image masks may be created for identifying the missing data in each of the input images.

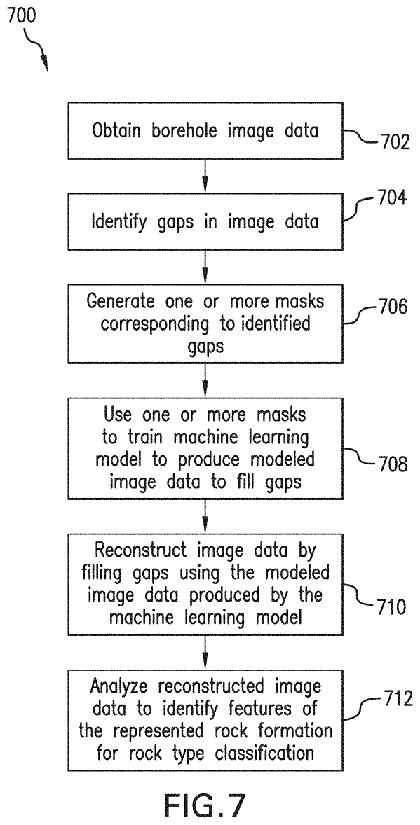

FIG. 7 is a flowchart of an illustrative process 700 for formation or borehole image gap-filling. For discussion purposes, process 700 will be described using system 200 of FIG. 2, as described above, but process 700 is not intended to be limited thereto.

As shown in FIG. 7, process 700 begins in block 702, which includes obtaining image data. Such image data may be, for example and without limitation, depth-defined logs including location data associated with each image log.

In block 704, the process 700 includes analyzing the obtained image data to identify gaps of missing data. In one or more embodiments, the image data obtained in block 702 may include a plurality of image logs and the gaps may be identified in at least one of the obtained image logs.

In block 706, one or more image masks corresponding to the gaps, e.g., as identified in at least one image log, are generated. In some embodiments, any noise or spurious data in the image mask(s) generated in block 706 may be removed using, for example, a morphological image processing operation like dilatation.

Process 700 then proceeds to block 708, which includes training a machine learning model to produce modeled image data for filling in the missing image data in the gaps identified in the at least one image log, based on the one or more generated image masks. The machine learning model may be implemented using, for example, deep learning model 242 of FIG. 2, as described above. In this regard, the deep learning model may be a 3D U-Net model. Further, training the deep learning model may involve training the deep learning model to perform automatic color equalization of the image log. In particular, training the deep learning model may involve using training data (e.g., image data 232 and image masks 234 of FIG. 2, as described above) to train the deep learning model to apply dynamic color to the image log.

In some implementations, the deep learning model may be trained to identify gaps of missing image data by mapping an input, such as an input image and/or image data from a training image dataset, to an output, such as one or more binary images, which may then be used to generate corresponding image masks. The output produced by the deep learning model may include, for example, a masked binary image with each image element (or corresponding mask) set to either one or zero depending on whether or not the corresponding element (e.g., pixel or voxel) of the input image contains data (e.g., set mask to one if the pixel or voxel contains data or set it to zero if it does not contain data). In one or more embodiments, the deep learning model may be configured to identify correlations and/or patterns between image elements across a set of image data that are each mapped to a particular output channel. In some embodiments, the deep learning model may, based on an evaluation of the training image data and an image mask, determine that an image element with an intensity within a first range may correspond to the contains data channel, while an image element with an intensity within a second range may correspond to the does not contain data channel. In this way, the deep learning model may account for variations in intensities of similar features (e.g., different rock types, facies or minerals may have a different dynamic color) between different images, which may result from differences in equipment and/or imaging modalities used to obtain the images, for example. Further, because an expected output (e.g., image mask) for a given image of the training image data may be included in the training image mask data, the training of the deep learning model may be supervised or unsupervised. However, embodiments are not limited thereto. In some embodiments, for example, a deep learning model may be trained to perform unsupervised image mask creation.

For instance, the deep learning model may be configured to identify correlations and/or patterns between image elements across a set of image data that are each mapped to a particular location in the image. In some embodiments, for example, the deep learning model may, based on an evaluation of the training image data and the image mask, determine that an image element with an intensity within a first range may correspond to valid data, while an image element with an intensity within a second range may correspond to missing data. Additionally or alternatively, the deep learning model may determine that a relative intensity of an image element with respect to other image elements in an image may correspond to a particular rock type. In this way, the deep learning model may account for variations in intensities of similar features (e.g., minerals, pores, porous medium, and/or the like) between different images, which may result from differences in equipment and/or imaging modalities used to obtain the images, for example. Further, because an expected output for a given image of the training image data may be included in the training segmentation data, the training of the deep learning model may be supervised. However, embodiments are not limited thereto.

Furthermore, the deep learning model may perform partial convolutions at leach location that the image mask is set to a value indicating that the corresponding data in the sample image data is real data and not a gap. Subsequently, a partial convolution of the sample image at a specific pixel or voxel of the image and/or image data provided by the deep learning model may be compared against another image and/or image data included in the image data captured by a different tool at the same depth and location. Further, in some embodiments, the comparison of the image data by the deep learning model or of the validation data may be performed based on an individual image or set of images.

In block 710, a reconstructed image of the borehole is generated by filling the gaps of missing image data (identified in block 704) in the borehole image data, e.g., in at least one image log (obtained in block 702) with the modeled image data produced by the deep learning model.

In block 712, the reconstructed image may be analyzed to identify features of the represented rock formation for rock type evaluation and classification. For example, the reconstructed image may be analyzed to determine characteristics of the reservoir formation. In some embodiments, the analyzed image may assist with facies interpretation and well planning.

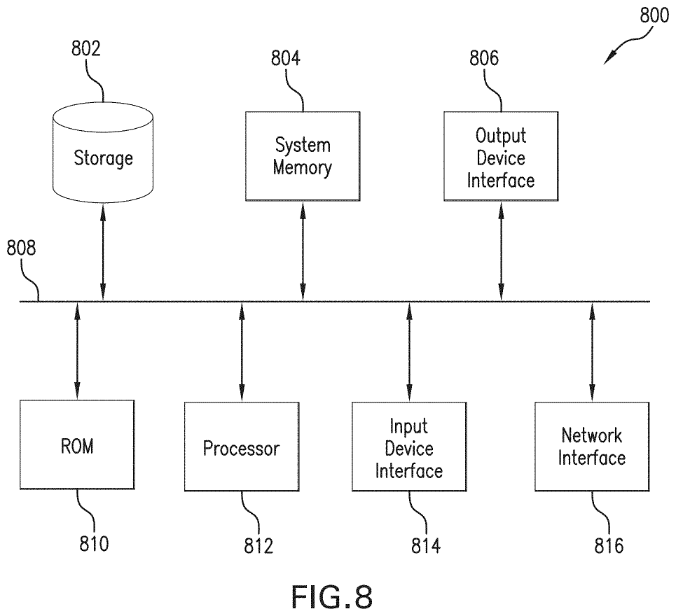

FIG. 8 is a block diagram of an exemplary computer system 800 in which embodiments of the present disclosure may be implemented. For example, system 200 of FIG. 2, as described above, may be implemented using system 800. System 800 can be a computer, phone, PDA, or any other type of electronic device. Such an electronic device includes various types of computer readable media and interfaces for various other types of computer readable media. As shown in FIG. 8, system 800 includes a permanent storage device 802, a system memory 804, an output device interface 806, a system communications bus 808, a read-only memory (ROM) 810, processing unit(s) 812, an input device interface 814, and a network interface 816.

Bus 808 collectively represents all system, peripheral, and chipset buses that communicatively connect the numerous internal devices of system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of system 800. Permanent storage device 802, on the other hand, is a read-and-write memory device. This device is a non-volatile memory unit that stores instructions and data even when system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such a random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for performing the image-gap-filling techniques disclosed herein. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the system 800. Input devices used with input device interface 814 include, for example, alphanumeric, QWERTY, or T9 keyboards, microphones, and pointing devices (also called “cursor control devices”). Output device interfaces 806 enables, for example, the display of images generated by the system 800. Output devices used with output device interface 806 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 8, bus 808 also couples system 800 to a public or private network (not shown) or combination of networks through a network interface 816. Such a network may include, for example, a local area network (“LAN”), such as an Intranet, or a wide area network (“WAN”), such as the Internet. Any or all components of system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the operations in process 700 of FIG. 7, as described above, may be implemented using system 800 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

As described above, embodiments of the present disclosure are particularly useful for automatically filling in gaps of missing image data within an image of a rock formation. Accordingly, advantages of the present disclosure include a fully automated process for image gap-filling and facies interpretation using the gap-filled image.

In one embodiment of the present disclosure, a computer-implemented method of image gap-infilling includes: obtaining, by a computing device communicatively coupled to an imaging tool disposed within a borehole, an image of a rock formation; analyzing, by the computing device, the obtained image to identify gaps of missing image data; generating one or more image masks corresponding to the gaps identified in the analyzed image; training a machine learning model to produce modeled image data for filling in the missing image data in the gaps identified in the image, based on the one or more generated image masks; reconstructing the image by filling the gaps of missing image data with the modeled image data produced by the machine learning model; and analyzing the reconstructed image to identify geological features of the rock formation.

Likewise, embodiments of a computer-readable storage medium having instructions stored therein have been described, where the instructions, when executed by a processor, may cause the processor to perform a plurality of functions, including functions to: obtain, from an imaging tool disposed within a borehole, an image of a rock formation; analyze the obtained image to identify gaps of missing image data; generate one or more image masks corresponding to the gaps identified in the analyzed image; train a machine learning model to produce modeled image data for filling in the missing image data in the gaps identified in the image, based on the one or more generated image masks; reconstruct the image by filling the gaps of missing image data with the modeled image data produced by the machine learning model; and analyze the reconstructed image to identify geological features of the rock formation.

The foregoing embodiments of the method or computer-readable storage medium may include any one or any combination of the following elements, features, functions, or operations: the obtained image of the rock formation includes a two-dimensional (2D) scalar array of numerical values representing a portion of the rock formation at a corresponding depth of the imaging tool when the image was captured within the rock formation; generating the one or more image masks comprises clustering image data associated with the obtained image to identify image gaps and generating one or more image masks, based on the clustered image data, where the one or more image masks include values representing valid image elements and invalid image elements within the image, and the invalid image elements correspond to the identified gaps of missing image data, each image element is at least one of a pixel or a voxel at a corresponding location within the image; generating the one or more image masks further comprises processing the clustered image data to reduce noise and generating the one or more image masks, based on the processing; the machine learning model is a convolutional deep neural network; the convolutional deep neural network has a U-Net architecture including an encoding path that performs feature extraction at multiple levels to produce down-sampled image data and a decoding path for up-sampling the down-sampled image data produced by the encoding path; and training the convolutional deep neural network includes performing supervised image gap filling to produce the modeled image data.

Furthermore, embodiments of a system including at least one processor and a memory coupled to the processor(s) have been described, where the memory stores instructions, which, when executed by the processor(s), may cause the processor(s) to perform a plurality of functions, including functions to: obtain, from an imaging tool disposed within a borehole, an image of a rock formation; analyze the obtained image to identify gaps of missing image data, generate one or more image masks corresponding to the gaps identified in the analyzed image; train a machine learning model to produce modeled image data for filling in the missing image data in the gaps identified in the image, based on the one or more generated image masks; reconstruct the image by filling the gaps of missing image data with the modeled image data produced by the machine learning model; and analyze the reconstructed image to identify geological features of the rock formation.

The foregoing embodiments of the system may include any one or any combination of the following elements, features, functions, or operations: the obtained image of the rock formation includes a two-dimensional (2D) scalar array of numerical values representing a portion of the rock formation at a corresponding depth of the imaging tool when the image was captured within the rock formation; generating the one or more image masks comprises clustering image data associated with the obtained image to identify image gaps and generating one or more image masks, based on the clustered image data, where the one or more image masks include values representing valid image elements and invalid image elements within the image, and the invalid image elements correspond to the identified gaps of missing image data; each image element is at least one of a pixel or a voxel at a corresponding location within the image; generating the one or more image masks further comprises processing the clustered image data to reduce noise and generating the one or more image masks, based on the processing; the machine learning model is a convolutional deep neural network; the convolutional deep neural network has a U-Net architecture including an encoding path that performs feature extraction at multiple levels to produce down-sampled image data and a decoding path for up-sampling the down-sampled image data produced by the encoding path; and training the convolutional deep neural network includes performing supervised image gap filling to produce the modeled image data.

While specific details about the above embodiments have been described, the above hardware and software descriptions are intended merely as example embodiments and are not intended to limit the structure or implementation of the disclosed embodiments. For instance, although many other internal components of the system 800 are not shown, those of ordinary skill in the art will appreciate that such components and their interconnection are well known. In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A computer-implemented method of image gap-filling, the method comprising:
obtaining, by a computing device communicatively coupled to an imaging tool disposed within a borehole, an image of a rock formation;
analyzing, by the computing device, the obtained image to identify gaps of missing image data;
generating one or more image masks corresponding to the gaps identified in the analyzed image;
training a machine learning model to produce modeled image data for filling in the missing image data in the gaps identified in the image, based on the one or more generated image masks;
reconstructing the image by filling the gaps of missing image data with the modeled image data produced by the machine learning model; and
analyzing the reconstructed image to identify geological features of the rock formation.

2. The computer-implemented method of claim 1, wherein the obtained image of the rock formation includes a two-dimensional (2D) scalar array of numerical values representing a portion of the rock formation at a corresponding depth of the imaging tool when the image was captured within the rock formation.

3. The computer-implemented method of claim 1, wherein generating the one or more image masks comprises:
clustering image data associated with the obtained image to identify image gaps; and
generating one or more image masks, based on the clustered image data, the one or more image masks including values representing valid image elements and invalid image elements within the image, and the invalid image elements corresponding to the identified gaps of missing image data.

4. The computer-implemented method of claim 3, wherein each image element is at least one of a pixel or a voxel at a corresponding location within the image.

5. The computer-implemented method of claim 3, wherein generating the one or more image masks further comprises:
processing the clustered image data to reduce noise; and
generating the one or more image masks, based on the processing.

6. The computer-implemented method of claim 1, wherein the machine learning model is a convolutional deep neural network.

7. The computer-implemented method of claim 6, wherein the convolutional deep neural network has a U-Net architecture including an encoding path that performs feature extraction at multiple levels to produce down-sampled image data and a decoding path for up-sampling the down-sampled image data produced by the encoding path.

8. The computer-implemented method of claim 6, wherein training the convolutional deep neural network includes performing supervised image gap filling to produce the modeled image data.

9. A system comprising:
at least one processor; and
a memory coupled to the at least one processor having instructions stored therein, which when executed by the at least one processor, cause the at least one processor to perform functions including functions to:
obtain, from an imaging tool disposed within a borehole, an image of a rock formation;
analyze the obtained image to identify gaps of missing image data;
generate one or more image masks corresponding to the gaps identified in the at least one image log;
train a machine learning model to produce modeled image data for filling in the missing image data in the gaps identified in the analyzed image, based on the one or more generated image masks;
reconstruct the image by filling the gaps of missing image data with the modeled image data produced by the machine learning model; and
analyze the reconstructed image to identify geological features of the rock formation.

10. The system of claim 9, wherein the obtained image of the rock formation includes a two-dimensional (2D) scalar array of numerical values representing a portion of the rock formation at a corresponding depth of the imaging tool when the image was captured within the rock formation.

11. The system of claim 9, wherein the functions performed by the at least one processor further include functions to:
cluster image data associated with the obtained image to identify image gaps;
process the clustered image data to reduce noise; and
generate one or more image masks with values representing valid image elements and invalid image elements in the image, the invalid image elements corresponding to the identified gaps of missing image data.

12. The system of claim 9, wherein the machine learning model is a convolutional deep neural network.

13. The system of claim 12, wherein the convolutional deep neural network has a U-Net architecture including an encoding path that performs feature extraction at multiple levels to produce down-sampled image data and a decoding path for up-sampling the down-sampled image data produced by the encoding path.

14. The system of claim 12, wherein the convolutional deep neural network is trained by performing supervised image gap filling to produce the modeled image data.

15. A computer-readable storage medium having instructions stored therein, which when executed by a computer cause the computer to perform a plurality of functions, including functions to:
obtain, from an imaging tool disposed within a borehole, an image of a rock formation;
analyze the obtained image to identify gaps of missing image data;
generate one or more image masks corresponding to the gaps identified in the analyzed image;
train a machine learning model to produce modeled image data for filling in the missing image data in the gaps identified in the image, based on the one or more generated image masks;
reconstruct the image by filling the gaps of missing image data with the modeled image data produced by the machine learning model; and
analyze the reconstructed image to identify geological features of the rock formation.

16. The computer-readable storage medium of claim 15, wherein the obtained image of the rock formation includes a two-dimensional (2D) scalar array of numerical values representing a portion of the rock formation at a corresponding depth of the imaging tool when the image was captured within the formation.

17. The computer-readable storage medium of claim 15, wherein the functions performed by the computer further include functions to:
cluster image data associated with the obtained image to identify image gaps,
process the clustered image data to reduce noise; and
generate one or more image masks with values representing valid image elements and invalid image elements in the image log, the invalid image elements corresponding to the identified gaps of missing image data.

18. The computer-readable storage medium of claim 15, wherein the machine learning model is a convolutional deep neural network.

19. The computer-readable storage medium of claim 18, wherein the convolutional deep neural network has a U-Net architecture including an encoding path that performs feature extraction at multiple levels to produce down-sampled image data and a decoding path for up-sampling the down-sampled image data produced by the encoding path.

20. The computer-readable storage medium of claim 18, wherein the convolutional deep neural network is trained by performing supervised image gap filling to produce the modeled image data.
